(19) United States
(12) Patent Application Publication
(10) Pub. No.: US 2026/0245118 A1
(43) Pub. Date: Aug. 20, 2026

(54) A METHOD FOR PROVIDING CONTENT TO A USER AND A SYSTEM THEREOF

(71) Applicant: INFOTRENDS SOFTWARE SOLUTIONS PRIVATE LIMITED, Hyderabad (IN)

(72) Inventors: Kshitij Prasad TIWARI, Hyderabad (IN); Alamelu KRISHNAMOORTHY, Hyderabad (IN)

(21) Appl. No.: 18/836,751

(22) PCT Filed: Jul. 8, 2024
(86) PCT No.: PCT/IB2024/056651

§ 371 Date: Aug. 7, 2024

(30) Foreign Application Priority Data
Jul. 22, 2023 (IN) 202341036585

(51) Int. Cl. G06Q 30/0251; G06N 20/00

(52) U.S. Cl. CPC G06Q 30/0269; G06N 20/00

(57) ABSTRACT

The present invention relates to a system and a method for providing content to users based on their preferences, and interests. It involves the creation of user profiles based on input data reflecting user intent, preferences, and interests. These profiles are segmented and analyzed using machine learning techniques to identify relevant users for specific content. The method encompasses various forms of content, including posts, polls, promotions, advertisements, and inquiries, which are tailored to match the preferences of targeted user groups. Furthermore, the invention incorporates data analytics to generate insights from user interactions and engagement metrics, facilitating informed decision-making. Feedback mechanisms are integrated to refine content recommendations, ensuring continual improvement in user experience. Overall, the method enables efficient and personalized content delivery, enhancing user satisfaction and engagement across diverse platforms.

### TECHNICAL FIELD

The present subject matter described herein, in general, relates to a digital platform for connecting users. More particularly, the present subject matter relates to a platform to enable a digital ecosystem for users to connect, consume, and form communities.

### BACKGROUND

This section is intended to introduce the reader to various aspects of art (the relevant technical field or area of knowledge to which the invention pertains), which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The number of sources used in research is high, but gaps can occur even with a systematic review. Advertising systems create and manage segmentation and targeting options without an officially published document, so changes in the system can only be determined using secondary data. In digital platforms, user action, not necessarily intent or consent, controls the user experience. Typically, the content provided to users is based on user behavior while navigating through a platform or based on user behavior while using an electronic device such as a mobile device. However, the user's behavior may not always correspond to the user's intent. The user's intent may be distinct from the user behavior. Traditional digital platforms focus on providing content to users based on user behavior and thus irrelevant content may be provided to the user leading to an undesirable user experience. Additionally, instead of segmenting users based on their intentions, preferences, and interests, digital platforms segment users based on their demographic (and maybe designation/company) information. Instead of focusing on users' preferences, intentions, and interests, digital platforms target people based on their activity and behaviour on the platform. Thus, these communications are not very effective or efficient.

Promotion, Advertisement & Inquiry features combined with User Preference selections determine how a Promoter/Advertiser will reach out to prospective audiences. These selections also determine how a user can post specific business requirements and reach out to a targeted audience. Targeting is based on user preference and consent. Typically, digital platforms target users based on their behavior and their activity on the platform rather than their preference, intent and interests. Owing to the above cited issues, the efficiency and efficacy of these communications is low.

Digital platforms segment users based on their demographic and company information, not their preferences, intentions, and interests. This is not effective or efficient, as it targets people based on their activity and behaviour on the platform. There are systems that allow users to connect/reach out, but their effectiveness is reliant on user behaviour and personal connection.

Traditional recommendation systems often infer user interests based on behavior (e.g., browsing history, clicks), which may not accurately reflect the user's true preferences or intent. This can result in the delivery of irrelevant content, leading to poor user experience.

Traditional business platforms face significant limitations, particularly in their targeting capabilities. Firstly, these platforms often lack advanced targeting and personalization capabilities, making it difficult for businesses to reach their desired audience segments effectively. Without precise targeting options, businesses may struggle to connect with the right partners, suppliers, or customers. This limitation can lead to wasted resources and missed opportunities for collaboration and growth. Traditional platforms often target users based on aggregated behavior data, leading to broad and generalized content recommendations. This can be inefficient, as it fails to personalize the content to individual user needs, reducing the effectiveness of promotions and advertisements. Further, many content recommendation systems operate without explicit user consent, using inferred data to push content. This can lead to privacy concerns and a lack of control for users over the type of content they receive

Users have to navigate between various tools and platforms to manage different aspects of their content strategy, including creation, distribution, and analytics. This not only wastes time but also increases the likelihood of errors and inefficiencies. It creates a cumbersome workflow that hinders the seamless execution of marketing and engagement activities, thus detracting from the user's ability to effectively manage their campaigns.

Traditional platforms are also limited in the types of content they support. This limitation restricts the creative potential and engagement opportunities for users, making their content less compelling and less likely to capture the attention of their audience. Finding relevant products or services on conventional B2B platforms is challenging due to limited search functionalities or categorization options. Businesses may struggle to discover new suppliers, products, or technologies that could benefit their operations.

The inefficiencies extend to the manual processes required for content creation, distribution, and analysis. These labour-intensive processes are prone to errors and consume significant time, reducing overall productivity. Additionally, traditional platforms often do not offer scheduling options for posts, polls, promotions and advertisements. Users must manually manage the timing and duration of their campaigns, which can lead to missed opportunities and inefficient use of resources.

Thus, there is a long-felt need for a digital platform with the ability to reach out to specific audience sets for posts, polls, promotions, advertisements, and inquiries with higher efficiency and efficacy. The proposed digital platform aims to address these issues by providing an integrated ecosystem that brings all stakeholders together, offering Post, Poll, Promotion, Advertisement, and Inquiry features combined with user preference selection.

In view of the above, addressing the aforementioned technical challenges requires an improved method and system for delivering highly relevant and personalized content to users based on their explicit preferences, intent, and consent, rather than relying solely on inferred behaviours. This improved approach aims to enhance user satisfaction, increase the efficiency of content delivery, and ensure user privacy and control over their data.

Further limitations and disadvantages of conventional and traditional approaches will become apparent to one of skill in the art, through the comparison of described systems with some aspects of the present disclosure, as set forth in the remainder of the present application and with reference to the drawings.

### SUMMARY

This summary is provided to introduce concepts related to a method for providing content to a user and the concepts are further described below in the detailed description. This summary is not intended to identify essential features of the claimed subject matter nor is it intended for use in determining or limiting the scope of the claimed subject matter.

According to embodiments illustrated herein, there is provided a method for providing content to a user. In one implementation of the present disclosure, the method may involve receiving a user input indicative of user intent, preferences, and user interests. The user input may be utilized to create one or more user profiles associated with one or more users. Further, the method involves segmenting these user profiles of one or more users based on the user input. Further the method involves receiving content from one or more users. The content may correspond to atleast one of a post, poll, promotion, an advertisement, and an inquiry. Further, the method may involves automatically identifying relevant profiles to provide content to one or more relevant users using a suitable machine learning technique, algorithms or logic. Furthermore, the method may involve provide content to the one or more relevant users corresponding to the one or more relevant profiles. The content may be tailored based on the user input and the segmented profile.

The one or more users may include consultants, manufacturers, innovators, experts, suppliers, or service providers. Further the user input may comprise a selection of at least one of an industry type, a sub-industry type, an area of interest, categories, technologies, knowledge areas, and countries. Further the one or more user profiles may comprise detailed information on user intent/interests, historical interactions, engagement metrics, industry types, sub-industry types, areas of interest, and professional roles.

Further, segmentation of one or more user profiles may involve organizing the user input into one or more categorical data, converting the categorical data into numerical vectors, applying one or more clustering techniques to group one or more profiles together and further grouping the one or more profiles into one or more distinct user group through labelling for easy identification. The categorical data comprises industry types, sub-industry types, areas of interest and professional roles.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram that illustrates a system environment (100) for providing content to a user, in accordance in an embodiment of the present disclosure.

FIG. 2 is a block diagram (200) that illustrates various components of an application server (104) configured for performing steps for providing content to a user, in accordance with an embodiment of the present disclosure.

FIG. 3 is a flowchart (300) that illustrates a method for providing content to a user, in accordance with an embodiment of the present disclosure; and

FIG. 4 illustrates a block diagram (400) of an exemplary computer system for implementing embodiments consistent with the present disclosure.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented, and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The present disclosure relates to a method for providing content to a user. The method may be implemented by an electronic device including a processor and a memory communicatively coupled to the processor and the memory is configured to store processor-executable instructions. The method includes receiving a user input. The received user input is indicative of user intent, preferences, and interests. The method uses this user input to create one or more user profiles associated with one or more users. The processor then segments these profiles based on the input data. Next, it receives content from users, such as posts, polls, promotions, advertisements, and inquiries. Using machine learning techniques, the processor may automatically identify one or more relevant user profiles associated with one or more users, that match the content. The tailored content is then delivered to these relevant users through various formats, including text, images, video, or audio. Additionally, the method involves performing data analytics on user interactions and feedback to generate insights, which helps to refine and improve future content recommendations and strategies.

The objective of the present disclosure is to provide an improved method and system for delivering highly relevant and personalized content to users based on their explicit preferences, intent, and consent.

Another objective of the present disclosure is to enhance user satisfaction by ensuring that the content delivered aligns closely with user intent and preferences, rather than relying solely on inferred behaviours.

Another objective of the present disclosure is to increase the efficiency and efficacy of delivering content, posts, polls, promotions, and advertisements through advanced segmentation and targeting techniques.

Yet another objective of the present disclosure is to ensure user privacy and control over their data by emphasizing explicit user consent and preferences in the content delivery process.

Yet another objective of the present disclosure is to provide continuous improvement of performance and accuracy over time.

Yet another objective of the present disclosure is to create a digital platform that facilitates seamless collaboration and networking among manufacturers, suppliers, innovators, service providers and industry experts.

Yet another objective of the present disclosure is to implement advanced machine learning/algorithms/logic techniques to accurately match content with user profiles, resulting in higher-quality recommendations and targeted communications.

Yet another objective of the present disclosure is to increase efficiency of the content delivery through targeting users based on well-segmented profiles, thereby reducing wasted resources on relevant recommendations.

Yet another objective of the present disclosure is to provide a user-friendly interface that allows users to easily input and manage their preferences, intent, and interests, ensuring a personalized and intuitive experience.

Yet another objective of the present disclosure is to support the scheduling of posts, polls, promotions advertisements and inquiries, giving users flexibility in planning and executing their marketing campaigns.

Yet another objective of the present disclosure is to foster an inclusive and transformative experience for all stakeholders in the manufacturing industry, promoting growth, innovation, and the development of market-dominating products.

Additionally, another objective of the present disclosure aims to provide valuable feedback, recommendations, and strategic guidance to users who post inquiries, helping them make informed decisions regarding the procurement of products, expertise in making products and services and receiving expert guidance to run their businesses more effectively.

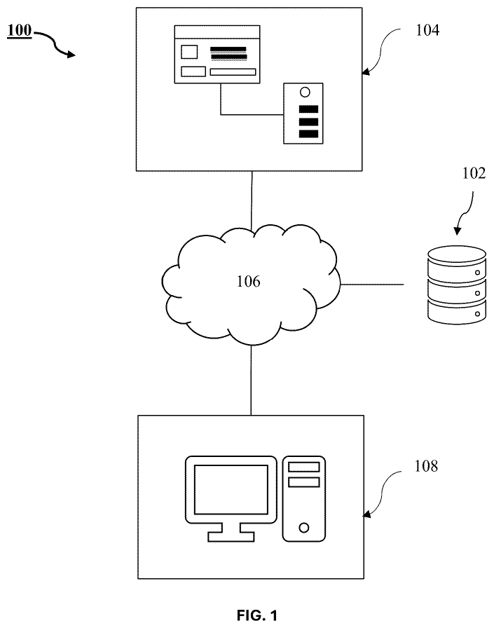

FIG. 1 is a block diagram that illustrates a system environment (100) for providing content to a user, in accordance in an embodiment of the present disclosure. The system environment (100) typically includes a database server (102), an application server (104), a communication network (106), and a user computing device (108). The database server (102), the application server (104), and the user computing device (108) are typically communicatively coupled with each other via the communication network (106). In an embodiment, the application server (104) may communicate with the database server (104), and the user computing device (108) using one or more protocols such as, but not limited to, Hypertext Transfer Protocol (HTTP), Transmission Control Protocol/Internet Protocol (TCP/IP), Wireless Application Protocol (WAP), RF mesh, Bluetooth Low Energy (BLE), and the like, to communicate with one another.

In an embodiment, the database server (102) may refer to a computing device that may be configured to store the multimedia content of one or more genres that may be showcased at one or more locations. In an embodiment, the database server (102) may include a special purpose operating system specifically configured to perform one or more database operations on multimedia content. Examples of database operations may include, but are not limited to, Select, Insert, Update, and Delete. In an embodiment, the database server (102) may include hardware that may be configured to perform one or more predetermined operations. In an embodiment, the database server (102) may be realized through various technologies such as, but not limited to, Microsoft® SQL Server, Oracle®, IBM DB2®, Microsoft Access®, PostgreSQL®, MySQL®, SQLite®, distributed database technology and the like. In an embodiment, the database server (102) may be configured to utilize the application server (104) for storage and retrieval of data used for providing content to the one or more users on a digital platform.

A person with ordinary skills in art will understand that the scope of the disclosure is not limited to the database server (102) as a separate entity. In an embodiment, the functionalities of the database server (102) can be integrated into the application server (104) or into the user computing device (108).

In an embodiment, the application server (104) may refer to a computing device or a software framework hosting an application or a software service. In an embodiment, the application server (104) may be implemented to execute procedures such as, but not limited to, programs, routines, or scripts stored in one or more memories for supporting the hosted application or the software service. In an embodiment, the hosted application or the software service may be configured to perform one or more predetermined operations. The application server (104) may be realized through various types of application servers such as, but are not limited to, a Java application server, a .NET framework application server, a Base4 application server, a PHP framework application server, or any other application server framework.

In an embodiment, the application server (104) may be configured to utilize the database server (102) and the user computing device (108), in conjunction, for providing content to one or more users on a digital platform. In an implementation, the application server (104) corresponds to the user interface platform for providing content to the one or more users on the digital platform.

In an embodiment, the communication network (106) may correspond to a communication medium through which the application server (104), the database server (102), and the user computing device (108) may communicate with each other. Such a communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Wireless Application Protocol (WAP), File Transfer Protocol (FTP), ZigBee, EDGE, infrared IR), IEEE 802.11, 802.16, 2G, 3G, 4G, 5G, 6G, 7G cellular communication protocols, and/or Bluetooth (BT) communication protocols. The communication network (106) may either be a dedicated network or a shared network. Further, the communication network (106) may include a variety of network devices, including routers, bridges, servers, computing devices, storage devices, and the like. The communication network (106) may include, but is not limited to, the Internet, intranet, a cloud network, a Wireless Fidelity (Wi-Fi) network, a Wireless Local Area Network (WLAN), a Local Area Network (LAN), a cable network, the wireless network, a telephone network (e.g., Analog, Digital, POTS, PSTN, ISDN, xDSL), a telephone line (POTS), a Metropolitan Area Network (MAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

In an embodiment, the user computing devices (108) may refer to a computing device used by a user. The user computing devices (108) may comprise of one or more processors and one or more memory. The one or more memories may include computer readable code that may be executable by one or more processors to perform predetermined operations. In an embodiment, the user computing devices (108) may present a web user interface to transmit the training file and the testing file to the application server (102). Example web user interfaces are presented on the user computing devices (108) to display a portal visualizing user profiles and relevant information, to provide content to one or more users. Examples of the user computing devices (108) may include but are not limited to, a personal computer, a laptop, a personal digital assistant (PDA), a mobile device, a tablet, or any other computing device.

The system (100) can be implemented using hardware, software, or a combination of both, which includes using where suitable, one or more computer programs, mobile applications, or “apps” by deploying either on-premises over the corresponding computing terminals or virtually over cloud infrastructure. The system (100) may include various micro-services or groups of independent computer programs which can act independently in collaboration with other micro-services. The system (100) may also interact with a third-party or external computer system. Internally, the system (100) may be the central processor of all requests for transactions by the various actors or users of the system. A critical attribute of the system (100) is that it can concurrently and instantly complete an online transaction by a system user in collaboration with other systems. In a specific embodiment, the system (100) is implemented to provide content to one or more users on the digital platform.

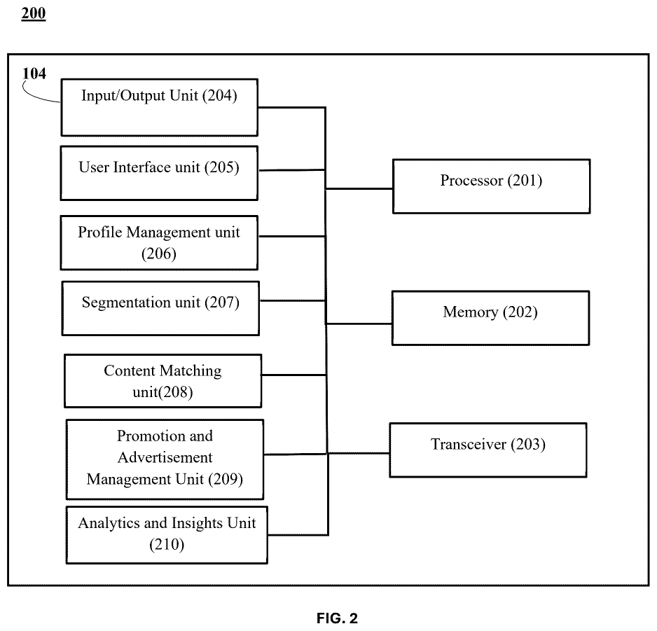

FIG. 2, illustrates a block diagram (200) illustrating various components of the application server (104) configured for stepwise delivering personalized content based on user preferences, intent, and consent, in accordance with an embodiment of the present invention. The block diagram (200) includes the following key components as a processor (201), a memory (202), a transceiver (203), an input/output unit (204), a user interface unit (205), a profile management unit (206), a segmentation unit (207), a content matching unit (208), a promotion and advertisement management unit (209) and an analytics and insight unit (210). The user interface unit (205) allows users to input their preferences, intent, and interests. It includes interfaces for various content formats such as text, image, video, and audio. Further, the profile management unit (206) is responsible for creating and maintaining user profiles based on the input provided by the users. These profiles include detailed information on user intent, interests, historical interactions, and engagement metrics. Further, the segmentation unit (207) organizes user profiles into distinct segments based on categorical data (e.g., industry type, sub-industry type, areas of interest, professional roles) and applies clustering techniques to group users with similar characteristics and intents. Further, the content matching unit (208) utilizes advanced machine learning techniques to automatically identify relevant profiles from the segmented groups. It matches content to user profiles by analyzing features extracted from the content and determining a similarity index. Further, the promotion and advertisement management unit (209) enable users to create and manage posts, polls, promotions advertisements and inquiries targeted to specific audience segments. It includes features for scheduling, A/B testing, and detailed performance analytics. Further, the analytics and insights unit (210) may provide comprehensive analytics on content performance, including direct results, comparison metrics, audience insights, and advanced recommendations. It supports A/B testing to optimize content delivery strategies.

The processor (201) comprises suitable logic, circuitry, interfaces, and/or code that may be configured to execute a set of instructions stored in the memory (202), and may be implemented based on several processor technologies known in the art. The processor (201) works in coordination with the transceiver (203), the input/output unit (204), the user interface unit (205), the profile management unit (206), the segmentation unit (207), the content matching unit (208), the promotion and advertisement unit (209), and the analytics and insights unit (210) for providing content to the user. Examples of the processor (201) include, but not limited to, a standard microprocessor, microcontroller, central processing unit (CPU), an X86-based processor, a Reduced Instruction Set Computing (RISC) processor, an Application-Specific Integrated Circuit (ASIC) processor, and a Complex Instruction Set Computing (CISC) processor, distributed or cloud processing unit, state machines, logic circuitries, and/or any devices that manipulate signals based on operational instructions and/or other processing logic that accommodates the requirements of the present invention.

The memory (202) comprises suitable logic, circuitry, interfaces, and/or code that may be configured to store the set of instructions, which are executed by the processor (201). Preferably, the memory (202) is configured to store one or more programs, routines, or scripts that are executed in coordination with the processor (201). Additionally, the memory (202) may include any computer-readable medium or computer program product known in the art including, for example, volatile memory, such as static random-access memory (SRAM) and dynamic random-access memory (DRAM), and/or non-volatile memory, such as read-only memory (ROM), erasable programmable ROM, a Hard Disk Drive (HDD), flash memories, Secure Digital (SD) card, Solid State Disks (SSD), optical disks, magnetic tapes, memory cards, virtual memory and distributed cloud storage. The memory (202) may be removable, non-removable, or a combination thereof. Further, the memory (202) may include routines, programs, objects, components, data structures, etc., which perform particular tasks or implement particular abstract data types. The memory (202) may include programs or coded instructions that supplement the applications and functions of the system (100). In one embodiment, the memory (202), amongst other things, serves as a repository for storing data processed, received, and generated by one or more of the programs or the coded instructions. In yet another embodiment, the memory (202) may be managed under a federated structure that enables the adaptability and responsiveness of the application server (104).

The transceiver (203) comprises suitable logic, circuitry, interfaces, and/or code that may be configured to receive, process or transmit information, data or signals, which are stored by the memory (202) and executed by the processor (201). The transceiver (203) is preferably configured to receive, process or transmit, one or more programs, routines, or scripts that are executed in coordination with the processor (201). The transceiver (203) is preferably communicatively coupled to the communication network (106) of the system (100) for communicating all the information, data, signals, programs, routines or scripts through the network.

The transceiver (203) may implement one or more known technologies to support wired or wireless communication with the communication network (106). In an embodiment, the transceiver (203) may include but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver (203) may communicate via wireless communication with networks, such as the Internet, an Intranet and/or a wireless network, such as a cellular telephone network, a wireless local area network (LAN) and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output (I/O) unit (204) comprises suitable logic, circuitry, interfaces, and/or code that may be configured to receive or present information. The input/output unit (204) comprises various input and output devices that are configured to communicate with the processor (201). Examples of the input devices include but are not limited to, a keyboard, a mouse, a joystick, a touch screen, a microphone, a camera, and/or a docking station. Examples of the output devices include, but are not limited to, a display screen and/or a speaker. The I/O unit (204) may include a variety of software and hardware interfaces, for example, a web interface, a graphical user interface, and the like. The I/O unit (204) may allow the system (100) to interact with the user directly or through the user computing devices (108). Further, the I/O unit (204) may enable the system (100) to communicate with other computing devices, such as web servers and external data servers (not shown). The I/O unit (204) can facilitate multiple communications within a wide variety of networks and protocol types, including wired networks, for example, LAN, cable, etc., and wireless networks, such as WLAN, cellular, or satellite. The I/O unit (204) may include one or more ports for connecting a number of devices to one another or to another server. In one embodiment, the I/O unit (204) allows the application server (104) to be logically coupled to other user computing devices (108), some of which may be built in. Illustrative components include tablets, mobile phones, wireless devices, etc.

FIG. 2 illustrates input/output (I/O) unit (204). Further, the input/output (I/O) unit (204) comprises may a display module, an input module, and a communication module. The display module may present content to the user, the input module may allow the user to provide preferences, interests, and other relevant information, and the communication module may facilitate the exchange of data between the user's device and the platform, ensuring seamless interaction and content delivery.

Further, FIG. 2 illustrates the user interface unit (205). Further, the user interface unit (205) comprises a display module, an input module, and a feedback module. The display module may present content to the user, the input module may allow the user to provide preferences, interests, and other relevant information, and the feedback module may enable the user to provide feedback on the content received. In one embodiment, the user interface unit (205) may be configured to receive content from the one or more users. The content corresponds to at least one of a post, poll, promotion, an advertisement, and an inquiry. Further, one or more insights are intended to offer valuable feedback, recommendations, and strategic guidance to the user who initiated the inquiry, assisting them in making informed decisions concerning the procurement of products, refining their product and service expertise, and receiving expert guidance to enhance the effectiveness of their business operations. These components work together to facilitate user interaction and improve the tailoring of content delivery based on user input and feedback.

Further, FIG. 2 illustrates the profile management unit (206). Further, the profile management unit (206) comprises a profile creation module operating in coordination with the memory (202). The profile creation module may be responsible for generating user profiles based on the user input indicative of user intent, preferences, and interests. The memory (202) may securely store all user profiles and associated data, ensuring quick retrieval and efficient management of user information. These components work together to create, manage, and utilize user profiles for delivering personalized content. The one or more users comprises at least one of a consultant, a manufacturer, an innovator, an expert, a supplier, or a service provider. Further, the user input comprises a selection of at least one of an industry type, a sub-industry type, an area of interest, categories, technologies, knowledge areas, and countries. The one or more user profiles comprises detailed information on user intent/interests, historical interactions, engagement metrics, industry types, sub-industry types, areas of interest, and professional roles.

Further, FIG. 2 illustrates the segmentation unit (207). Further, the segmentation unit (207) comprises a data categorization module, a vectorization module, and a clustering module. The segmentation unit (207) is configured to segment the one or more user profiles, associated with the one or more users, based on the received input. The data categorization module may be configured to organize the user input into categorical data such as, but not limited to, industry types, sub-industry type, areas of interest, and professional roles. In an exemplary embodiment, the categorical data comprises industry types such as technology, healthcare, finance, manufacturing, and retail. The sub-industry types may include fintech, biotech, e-commerce, automotive, and energy. Examples of areas of interest could be AI, machine learning, blockchain, cybersecurity, and renewable energy. Professional roles may encompass a wide range, including consultants, suppliers, manufacturers, innovators, researchers, and educators. Further, the vectorization module may convert this categorical data into numerical vectors using one or more vectorization techniques. In an embodiment, the one or more vectorization techniques correspond to one-hot encoding, label encoding, or embeddings representations. Further, the clustering module may apply one or more clustering techniques to group one or more user profiles together based on the numerical vectors. The one or more clustering algorithms comprise at least one of K-Means Clustering, Hierarchical Clustering, or Density-Based Spatial Clustering. Further, the clustering module may be configured for grouping one or more user profiles into one or more distinct user groups with similar characteristics and user intents. The user intents may be crucial for tailoring content effectively. Each of these one or more distinct user groups may be assigned a label for easy identification, potentially streamlining engagement strategies. For instance, labels like “Tech Enthusiasts” or “Healthcare Professionals” may provide clear identifiers for specific user clusters. However, the segmentation process may extend beyond these examples, encompassing a diverse array of interests and roles. Additional labelled groups may include “Financial Experts,” “Fashionistas,” “Environmental Activists,” and “Small Business Owners,” among others. By organizing users into these categorized segments, content providers can potentially streamline their approach, ensuring that posts, polls, promotions, advertisements, and inquiries are precisely tailored to resonate with each group's unique preferences and interests. This segmentation strategy may enhance user engagement and potentially maximize the impact of content delivery efforts, ultimately driving more meaningful interactions and fostering stronger connections with the user base. These components work together to segment user profiles effectively for tailored content delivery.

Further, FIG. 2 illustrates the content matching unit (208). Further, the content matching unit (208) comprises a feature extraction module, a similarity assessment module, and a relevance prediction module. The content matching unit (208) is configured to automatically identify one or more relevant profiles, from the one or more user profiles, associated with one or more relevant users, based on one or more machine learning techniques to provide content to the one or more relevant users. Further, the content matching unit (208) is configured to train one or more supervised learning model based on the user input and the data present in each of the one or more user profiles. The feature extraction module may utilize natural language processing (NLP) techniques to extract one or more features from the content. The one or more features may capture the semantic meaning of the content. The one or more features comprises a Term Frequency-Inverse Document Frequency (TF-IDF), word embeddings, and BERT embeddings. Further, the similarity assessment module may determine a similarity index between these extracted one or more features and the one or more user profiles. The similarity index is determined based on the trained supervised machine learning model using the labels assigned to each of the one or more distinct user group. Further, the relevance prediction module may be configured to predict the probability of relevance for each user profile-content pair based on the similarity index, ensuring that the most relevant content is matched to the appropriate user profiles. These components work together to identify and deliver the most pertinent content to the users based on their profiles and input.

Further, FIG. 2 illustrates the promotion and advertisement unit (209). Further, the promotion and advertisement unit (209) comprises a content delivery module and a scheduling module. The promotion and advertisement unit (209) may be configured to provide the content to the one or more relevant users corresponding to the one or more relevant profiles. The content is tailored based on the user input and the segmented user profiles. The content delivery module may be responsible for presenting posts, polls, promotions and advertisements to users through various formats, such as text, images, video, or audio. Users may gain the ability to target their posts, polls, and promotions effectively, selecting specific audience segments by selecting an industry type, sub-industry type, area of interest, categories, technologies, knowledge areas, engagement levels, locations, functions, and designations. The promotion and advertisement unit (209) may facilitate scheduling posts, polls, and promotions for immediate or future deployment to the one or more relevant users. The scheduling module may manage the timing and duration of these posts, polls, and promotions, allowing for content to be delivered immediately or at a future date, with customizable promotion periods and a default promotion duration of a specific number of days, or until served to the one or more relevant users. The promotion and advertisement unit (209) may provide options for A/B testing to optimize engagement by testing different content versions. These components work together to ensure efficient and effective delivery and assessment of promotional content.

Further, FIG. 2 illustrates the analytics and insights unit (210). Further, the analytics and insights unit (210) comprises a data analysis module, an insights generation module, and a feedback integration module. The data analysis module is configured to provide content analytics of atleast one of direct results impressions, views, clicks, and click-through rates (CTR), reactions, comments, shares, reposts, connections, and a combination thereof, to facilitate the comparison of content in terms of performance metrics, audience insights, segment reach, engagement levels, and geographic distribution. The provision of promotion analytics, including metrics like impressions, views, clicks, click-through rates (CTR), reactions, comments, shares, reposts, and connections, facilitates thorough performance evaluation. Further the insights generation module is configured to perform data analytics on the user input from the one or more users and the content to generate one or more insights. The one or more insights correspond to data-driven observations, trends, and actionable information derived from the analysis of user interactions, preferences, and engagement metrics. These insights, derived from user interactions and engagement data, inform future content, posts, polls, promotion, and advertisement strategies, enabling users to refine their targeting and timing. The one or more insights are aimed to provide valuable feedback, recommendations, and strategic guidance to the user who posted the inquiry, helping them make informed decisions regarding procurement of products, expertise in making products, services and receiving expert guidance to run their businesses more effectively. The inquiry may correspond to information to be received from the one or more relevant users. Upon providing the inquiry to the one or more relevant users, the one or more relevant users provides the information to a user, from the one or more users, who posted the inquiry The data analysis module may process user interactions, preferences, and engagement metrics to derive valuable insights. Additionally, the system offers tools, such as feedback integration module, for receiving feedback on provided content, which is then used for data analytics to enhance future recommendations for providing the content. Furthermore, interactive elements such as polls, quizzes, and surveys are integrated to engage users and gather additional preference data. Users are also empowered to customize their content feed based on preferred types, frequency of updates, and notification preferences. The content interface is designed to display recommendations in a personalized dashboard format, highlighting the most relevant content based on user preferences, thereby enhancing user experience and engagement. The insights generation module may generate actionable observations, trends, and recommendations based on the analyzed data. The feedback integration module may incorporate user feedback and performance metrics to refine insights and improve content recommendations. Together, these components facilitate the generation of meaningful analytics and insights, empowering users to make informed decisions and optimize content strategies.

In operation, the system (100) may function by first receiving user input, which could include intent, preferences, and interests. This input is then processed through various modules, such as the profile management unit (206), the segmentation unit (207) and content matching unit (208), to create tailored user profiles and match relevant content to these profiles. The promotion and advertisement unit (209) may handle the delivery of content to users, allowing for targeted promotions and advertisements based on user segments and preferences. Additionally, the analytics and insights unit (210) processes user interactions and engagement metrics to derive valuable insights, which inform future content strategies. Throughout this process, feedback from users may be incorporated to continually refine and enhance the system's recommendations and content delivery mechanisms.

In operation, the system (100) may function by first receiving user input indicative of user intent, preferences, and interests. This input may include selections of industry type, sub-industry type, areas of interest, categories, technologies, knowledge areas, and countries. For instance, a user may indicate an interest in the technology industry, specifically in the sub-industries of AI and machine learning. This user input may be processed by the system's processor to create detailed user profiles. These profiles may contain comprehensive information such as user intent, historical interactions, engagement metrics, and professional roles, providing a rich dataset to tailor the user experience. Once the profiles are created, the system (100) may segment them based on the received input. Segmentation may involve organizing the user input into categorical data, such as industry types, sub-industry types, areas of interest, and professional roles. This categorical data may then be converted into numerical vectors using techniques like one-hot encoding, label encoding, or embedding representations. Clustering techniques, such as K-Means Clustering, Hierarchical Clustering, or Density-Based Spatial Clustering, may be applied to group similar profiles together. The segmented profiles may be grouped into distinct user groups with similar characteristics and intents, and each group may be assigned a label for easy identification. The system (100) may then receive content from the users, which may be in the form of promotions, advertisements, or inquiries. For example, a manufacturer may post an advertisement about a new product, or a consultant may post an inquiry seeking information on the latest industry trends. The processor may use machine learning techniques to automatically identify relevant profiles from the segmented user groups that match the content. This identification may involve training a supervised machine learning model based on the user input and data in each profile. Features from the content may be extracted using NLP techniques, such as Term Frequency-Inverse Document Frequency (TF-IDF), word embeddings, and BERT embeddings, to capture the semantic meaning of the content. A similarity index may be determined between the features of the content and the user profiles, and the system may predict the probability of relevance for each user profile-content pair. Further, the tailored content may then be provided to the relevant users based on their segmented profiles and input. The content may be displayed on the user interface in various formats, including text, images, videos, or audio. This ensures that users may receive content in their preferred format, enhancing their engagement and experience. The system (100) may also perform data analytics on user interactions with the content to generate insights. These insights may include data-driven observations, trends, and actionable information derived from analyzing user interactions, preferences, and engagement metrics. This may help users make informed decisions regarding content creation, posts, poll and promotion strategies, and target audience selection. Furthermore, the platform may include feedback mechanisms allowing users to rate the relevance of the provided content. This feedback may be used to refine future content recommendations, ensuring that the system continually improves its ability to deliver valuable and targeted content to its users. Further, the one or more insights may aim to provide valuable feedback, recommendations, and strategic guidance to the user who posted the inquiry, helping them make informed decisions regarding procurement of products, expertise in making products and services and receiving expert guidance to run their businesses more effectively. By incorporating these detailed steps, the platform may provide a comprehensive solution for personalized content delivery, fostering a more engaging and effective user experience on the platform.

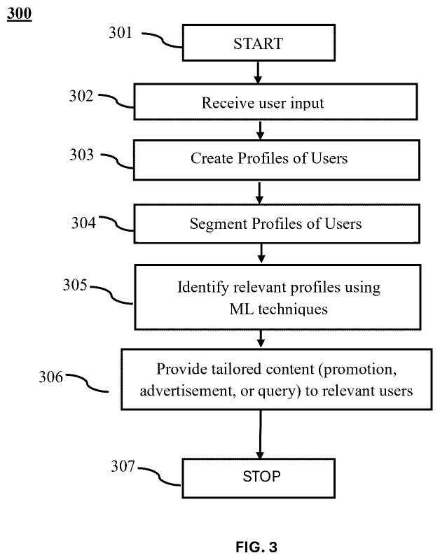

FIG. 3 is a flowchart that illustrates a method (300) for providing content to a user, in accordance with at least one embodiment of the present disclosure. The flowchart is described in conjunction with FIG. 1 and FIG. 2. The method (300) starts at step (301) and proceeds to step (307).

In operation, the method (300) may involve a variety of steps for providing content to the user.

At step (301), the method (300) is configured to start a method for providing content to the user on a digital platform. This initial step may involve receiving user input indicative of user intent, preferences, and interests.

At step (302), the method (300) is configured to receive a user input. The user input may include details indicative of user intent, preferences, and interests, which may be utilized to create one or more user profiles associated with the users. This step is essential for gathering the necessary data to personalize content delivery effectively.

At step (303), the method (300) is configured to create profiles of users. This step involves utilizing the received user input, which includes details of user intent, preferences, and interests, to establish detailed user profiles.

At step (304), the method (300) is configured to segment one or more user profiles associated with the user based on the received user input. This segmentation process organizes the profiles into distinct groups with similar characteristics and intents, enabling more targeted and effective content delivery.

At step (305), the method (300) is configured to identify relevant profiles using machine learning (ML) techniques. This step involves analyzing the user profiles and the received content to match the most suitable profiles based on their characteristics and input data, ensuring that the content is directed to the appropriate users.

At step (306), the method (300) is configured to provide tailored content (post, poll, promotion, advertisement, or inquiry) to relevant users. This step ensures that the content is specifically customized based on the identified relevant profiles, thereby enhancing the relevance and effectiveness of the content delivery. This content may correspond to at least one of post, poll, promotion, advertisement, or an inquiry, providing the necessary information for subsequent matching and delivery to relevant user profiles. This step ensures that the appropriate type of content is delivered based on the user's needs and preferences, enhancing user engagement and satisfaction with the content provided. Further, this step involves delivering tailored content to the users based on their identified profiles and preferences, ensuring that each user receives content that is relevant and personalized to their interests and needs. Furthermore, this step ensures that the content is presented to the users in a visually appealing and accessible manner, catering to their preferences and enhancing their overall experience with the provided content.

Let us delve into a detailed example of the present disclosure.

Imagine a digital platform designed to provide personalized content experiences for professionals in various industries, such as an online networking platform for consultants, manufacturers, innovators, experts, suppliers, and service providers.

Users sign up for the platform and provide inputs about their intent, preferences, and interests. This input includes selections of industry types, sub-industry types, areas of interest, technologies, knowledge areas, and countries. The platform's processor utilizes this input to create detailed user profiles for each user.

The processor segments the user profiles based on the provided input, organizing them into distinct groups with similar characteristics and intents.

Users submit content to the platform, which may include posts, polls, promotions, advertisements, or inquiries related to their professional activities and interests.

Using supervised machine learning techniques, the processor on the platform, automatically identifies relevant profiles for each submitted content based on the similarity between the content features and the characteristics of user profiles. This ensures that the content is directed to the most suitable users.

The platform provides the submitted content to the relevant users corresponding to the identified profiles. Content is tailored based on the user input and segmented profiles, ensuring it aligns with each user's professional interests and preferences.

The platform displays the content on the user interface in various formats, including images, text, videos, or audio. Users can access the content through personalized feeds, highlighting the most relevant content based on their profiles.

The platform performs data analytics on user interactions with the provided content to generate insights. These insights include performance metrics such as impressions, views, clicks, reactions, comments, and shares. User feedback on the provided content is also collected to refine future recommendations and improve content delivery, procurement of products, expertise in making products and services, and receiving expert guidance to run their businesses more effectively.

In a practical scenario, consider an online marketplace platform catering to various industries where users can post inquiries seeking specific information. For instance, a user posts an inquiry seeking recommendations for the latest technological advancements in the healthcare sector. Upon receiving the inquiry, the system identifies relevant users based on their expertise, engagement history, and industry affiliations. Through machine learning algorithms, the system matches inquiries with users who have demonstrated expertise in healthcare technology. These identified users then provide valuable insights and recommendations based on their knowledge and experience in the field.

Additionally, the system performs data analytics on both inquiries and responses from relevant users to generate actionable insights. These insights include trends in technological advancements, user engagement metrics, and recommendations for further exploration.

As the inquiry initiator, receives these insights, empowering users to make informed decisions regarding content creation, promotional strategies, and target audience selection within the platform. This process fosters a collaborative environment where users benefit from shared expertise, enhancing the overall quality of content and user engagement on the platform.

### Working Example

Let's envision a digital platform called “XYZ” designed to connect technology enthusiasts with industry experts, consultants, and innovators. The platform employs the method described in the claims to deliver tailored content to its users.

J explores “XYZ” website and learns about its mission to empower manufacturers like him. Intrigued by the platform's promise to foster collaboration and innovation, he decides to sign up.

Upon registration, J fills out his profile, highlighting his expertise in electronics manufacturing and his interest in exploring new technologies.

Through the “XYZ” platform, J connects with fellow manufacturers, suppliers, service providers and industry experts. J joins discussions on cutting-edge manufacturing techniques and shares his own insights.

J utilizes the “XYZ” platform to showcase his latest product innovations, including custom circuit boards and electronic modules. J uploads detailed descriptions and images to attract potential buyers.

To reach a broader audience, J decides to advertise his electronic components on the “XYZ” platform. Using the platform's targeted advertising feature, J selects segments related to electronics manufacturing and sets engagement levels and locations.

After running his advertisement campaign, J accesses the “XYZ” platform's advertising analytics. He reviews metrics such as impressions, clicks, and engagement rates to gauge the effectiveness of his campaign.

J also explores the “XYZ” platform's promotion feature to promote collaborations with other manufacturers and suppliers. J selects relevant audience segments and schedules promotions to showcase his partnership opportunities.

To gather feedback from the “XYZ” platform's community, J creates polls and inquiries about potential product enhancements and industry trends. J receives valuable insights from his connections, guiding his future business decisions.

Through the “XYZ” platform, J not only expands his network but also stays updated on the latest manufacturing trends and opportunities. The platform serves as a valuable resource for him to grow his business and collaborate with industry peer

A person skilled in the art will understand that the scope of the disclosure is not limited to scenarios based on the aforementioned factors and using the aforementioned techniques and that the examples provided do not limit the scope of the disclosure.

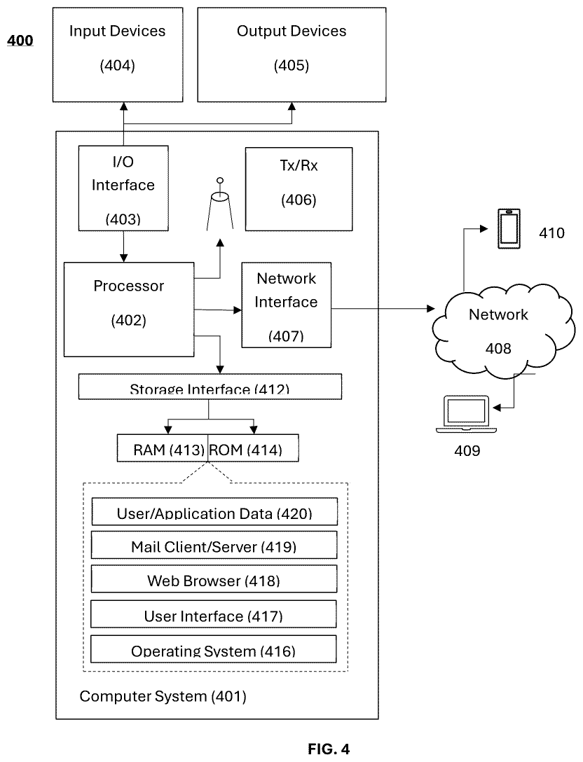

FIG. 4 illustrates a block diagram of an exemplary computer system (401) for implementing embodiments consistent with the present disclosure.

Variations of computer system (401) may be used for providing content to one or more users on a digital platform. The computer system (401) may comprise a central processing unit (“CPU” or “processor”) (402). The processor (402) may comprise at least one data processor for executing program components for executing user-or system-generated requests. A user may include a person, a person using a device such as such as those included in this disclosure, or such a device itself. Additionally, the processor (402) may include specialized processing units such as integrated system (bus) controllers, memory management control units, floating point units, graphics processing units, digital signal processing units, or the like. In various implementations the processor (402) may include a microprocessor, such as AMD Athlon, Duron or Opteron, ARM's application, embedded or secure processors, IBM PowerPC, Intel's Core, Itanium, Xeon, Celeron or other line of processors, for example. Accordingly, the processor (402) may be implemented using mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor (402) may be disposed in communication with one or more input/output (I/O) devices via I/O interface (403). Accordingly, the I/O interface (403) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like, for example.

Using the I/O interface (403), the computer system (401) may communicate with one or more I/O devices. For example, the input device (404) may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device (405) may be a user's smartphone, tablet, cell phone, laptop, printer, fax machine, video display (e.g., cathode ray tube (CRT), liquid crystal display (LCD), light-emitting diode (LED), plasma, or the like), or audio speaker, for example. In some embodiments, a transceiver (406) may be disposed in connection with the processor (402). The transceiver (406) may facilitate various types of wireless transmission or reception. For example, the transceiver (406) may include an antenna operatively connected to a transceiver chip (example devices include the Texas Instruments® WiLink WL1283, Broadcom® BCM4750IUB8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor (402) may be disposed in communication with a communication network (408) via a network interface (407). The network interface (407) is adapted to communicate with the communication network (408). The network interface (407) may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network (408) may include, without limitation, a direct interconnection, local area network (LAN), wide area network (WAN), wireless network (e.g., using Wireless Application Protocol), or the Internet, for example. Using the network interface (407) and the communication network (408), the computer system (401) may communicate with devices such as shown as a laptop (409) or a mobile/cellular phone (410). Other exemplary devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system (401) may itself embody one or more of these devices.

In some embodiments, the processor (402) may be disposed in communication with one or more memory devices (e.g., RAM 413, ROM 414, etc.) via a storage interface (412). The storage interface (412) may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system (416), user interface application (417), web browser (418), mail client/server (419), user/application data (420) (e.g., any data variables or data records discussed in this disclosure) for example. The operating system (416) may facilitate resource management and operation of the computer system (401). Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple IOS, Google Android, Blackberry OS, or the like.

The user interface (417) if for facilitating the display, execution, interaction, manipulation, or operation of program components through textual or graphical facilities. For example, user interfaces may provide computer interaction interface elements on a display system operatively connected to the computer system (401), such as cursors, icons, check boxes, menus, scrollers, windows, or widgets, for example. Graphical user interfaces (GUIs) may be employed, including, without limitation, Apple Macintosh operating systems' Aqua, IBM OS/2, Microsoft Windows (e.g., Aero, Metro, etc.), Unix X-Windows, or web interface libraries (e.g., ActiveX, Java, JavaScript, AJAX, HTML, Adobe Flash, etc.), for example.

In some embodiments, the computer system (401) may implement a web browser (418) stored program component. The web browser (418) may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system (401) may implement a mail client/server (419) stored program component. The mail server (419) may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, or WebObjects, for example. The mail server (419) may utilize communication protocols such as internet message access protocol (IMAP), messaging application programming interface (MAPI), Microsoft Exchange, post office protocol (POP), simple mail transfer protocol (SMTP), or the like. In some embodiments, the computer system (401) may implement a mail client (420) stored program component. The mail client (520) may be a mail viewing application, such as Apple Mail, Microsoft Entourage, Microsoft Outlook, or Mozilla Thunderbird.

In some embodiments, the computer system (401) may store user/application data (421), such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Various embodiments of the disclosure encompass numerous advantages including a method for providing content to a user. The disclosed method and system have several technical advantages, but not limited to the following:

Personalized Content Delivery: By utilizing user input to create detailed profiles and employing machine learning techniques for profile identification, the method ensures that content is tailored to each user's specific preferences and interests.

Enhanced User Engagement: Through the provision of relevant and personalized content, users are more likely to engage with the platform, leading to increased user satisfaction and retention.

Efficient Content Management: The segmentation of user profiles allows for efficient organization and delivery of content, ensuring that users receive content that is most relevant to them.

Data-driven Insights: The method includes analytics and feedback mechanisms to gather insights on user interactions and preferences, enabling continuous improvement of content recommendations and platform performance.

Flexibility and Customization: Users have the flexibility to customize their content feed and select preferred content types, frequency of updates, and notification preferences, enhancing their overall experience on the platform.

In summary, these technical advantages solve the technical problem of providing a personalized and efficient method for delivering content to users. Additionally, these advantages contribute to enhancing user satisfaction, increasing platform engagement, and optimizing content delivery strategies.

Furthermore, the invention involves a non-trivial combination of technologies and methodologies that provide a technical solution for a technical problem. While individual components like processors, databases, encryption, authorization and authentication are well-known in the field of computer science, their integration into a comprehensive system for providing content to one or more users in a digital platform, brings about an improvement and technical advancement in the field of providing relevant content to one or more users on the digital platform.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

What is claimed is:

1. A method (300) for providing content to a user, the method (300) comprises:
receiving (302), by a processor (201), a user input indicative of user intent, user preferences, and user interests, wherein the user input is utilized to create (303) one or more user profiles associated with one or more users;
segmenting (304), by the processor (201), the one or more user profiles associated with the one or more users based on the received user input;
receiving content from the one or more users, wherein the content corresponds to at least one of a post, poll, promotion, an advertisement, and an inquiry;
automatically identifying (305), by the processor (201), one or more relevant profiles, from the one or more user profiles, associated with one or more relevant users, based on one or more machine learning techniques to provide content to the one or more relevant users; and
providing (306), by the processor (201), the content to the one or more relevant users corresponding to the one or more relevant profiles, wherein the content is tailored based on the user input and the segmented profiles.

2. The method (300) as claimed in claim 1, wherein the one or more users comprises at least one of a consultant, a manufacturer, an innovator, an expert, a supplier, or a service provider.

3. The method (300) as claimed in claim 1, wherein the user input comprises a selection of at least one of an industry type, a sub-industry type, an area of interest, categories, technologies, knowledge areas, and countries.

4. The method (300) as claimed in claim 1, wherein the one or more user profiles comprises detailed information on user intent/interests, historical interactions, engagement metrics, industry types, sub-industry types, areas of interest, and professional roles.

5. The method (300) as claimed in claim 1, wherein segmenting (304) further comprises:
organizing the user input into one or more categorical data, wherein the categorical data comprises industry types, sub-industry types, areas of interest and professional roles;
converting the categorical data into numerical vectors using one or more techniques comprising one-hot encoding, label encoding, or embedding representations;
applying one or more clustering techniques to group one or more user profiles together based on the numerical vectors, wherein the clustering techniques comprise at least one of K-Means Clustering, Hierarchical Clustering, Density-Based Spatial Clustering;
grouping the one or more user profiles into one or more distinct user groups with similar characteristics and user intents, wherein each of the one or more distinct user groups is assigned a label for easy identification.

6. The method (300) as claimed in claim 5, wherein automatically identifying (305) one or more relevant profiles comprises:
training a supervised machine learning model based on the user input and data present in each of the one or more user profiles;
extracting one or more features from the content using NLP techniques, wherein the one or more features comprises a Term Frequency-Inverse Document Frequency (TF-IDF), word embeddings and BERT embeddings, wherein the one or more features capture the semantic meaning of the content;
determining a similarity index between the one or more features of the content and the one or more user profiles based on the trained supervised machine learning model using the labels assigned to each of the one or more distinct user groups; and
predicting a probability of relevance for each user profile-content pair based on the similarity index.

7. The method (300) as claimed in claim 1, wherein providing (306) the content comprises:
displaying the content on a user interface;
delivering the content through different formats, including image, text, video and or audio output.

8. The method (300) as claimed in claim 1, wherein the inquiry corresponds to information to be received from the one or more relevant users, wherein upon providing the inquiry to the one or more relevant users, the one or more relevant users provides the information to a user, from the one or more users, who posted the inquiry.

9. The method (300) as claimed in claim 1, wherein the method (300) comprises performing data analytics on the user input from the one or more users and the content to generate one or more insights, wherein the one or more insights correspond to data-driven observations, trends, and actionable information derived from the analysis of user interactions, preferences, and engagement metrics.

10. The method (300) as claimed in claim 9, wherein the one or more insights are aimed to provide valuable feedback, recommendations, and strategic guidance to the user who posted the inquiry, helping them make informed decisions regarding procurement of products, expertise in making products, services and receiving expert guidance to run their businesses more effectively.

11. The method (300) as claimed in claim 1, wherein the method (300) enables selecting an industry type, sub-industry type, area of interest, categories, technologies, knowledge areas, engagement levels, functions, and demographic information of the users, by the user who posted the inquiry.

12. The method (300) as claimed in claim 1, wherein the method (300) comprises creating a schedule for providing content to one or more relevant users, wherein the schedule comprises promotions to be provided at a future date or to provide immediately, with a default promotion duration of a specific number of days, or until served to the one or more relevant users.

13. The method (300) as claimed in claim 1, wherein the method (300) comprises providing content analytics of atleast one of direct results impressions, views, clicks, and click-through rates (CTR), reactions, comments, shares, reposts, connections, and a combination thereof, to facilitate the comparison of content in terms of performance metrics, audience insights, segment reach, engagement levels, and geographic distribution.

14. The method (300) as claimed in claim 1, comprises receiving feedback on the provided content, wherein the feedback is provided for the content analytics, to refine future recommendations for providing content.

15. A system (100) for providing content to a user, the system comprising:
a processor (201); and
a memory (202) communicatively coupled to the processor (201), wherein the memory (202) stores processor executable instructions, which, on execution, causes the processor (201) to:
receive a user input indicative of user intent, user preferences, and user interests, wherein the user input is utilized to create one or more user profiles associated with one or more users;
segment the one or more user profiles associated with the one or more users based on the received user input;
receive content from the one or more users, wherein the content corresponds to at least one of a post, poll, promotion, an advertisement, and an inquiry;
automatically identify one or more relevant profiles, from the one or more user profiles, associated with one or more relevant users, based on one or more machine learning/algorithms/logic techniques to provide content to the one or more relevant users; and
provide the content to the one or more relevant users corresponding to the one or more relevant profiles, wherein the content is tailored based on the user input and the segmented profiles.

16. A non-transitory computer-readable storage medium having stored thereon, a set of computer-executable instructions causing a computer comprising one or more processors to perform steps comprising:
receiving a user input indicative of user intent, user preferences, and user interests, wherein the user input is utilized to create (303) one or more user profiles associated with one or more users;
segmenting the one or more user profiles associated with the one or more users based on the received user input;
receiving content from the one or more users, wherein the content corresponds to at least one of a post, poll, promotion, an advertisement, and an inquiry;
automatically identifying one or more relevant profiles, from the one or more user profiles, associated with one or more relevant users, based on one or more machine learning techniques to provide content to the one or more relevant users; and
providing the content to the one or more relevant users corresponding to the one or more relevant profiles, wherein the content is tailored based on the user input and the segmented profiles.
